(19) United States
(12) Patent Application Publication
(10) Pub. No.: US 2003/0182363 A1
(43) Pub. Date: Sep. 25, 2003

(54) Providing private network local resource access to a logically remote device

(76) Inventors: James Clough, Boise, ID (US); Darrel D. Cherry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/107,233

(22) Filed: Mar. 25, 2002

(51) Int. Cl. G06F 15/16

(52) U.S. Cl. 709/203; 709/219

(57) ABSTRACT

The following described subject matter provides private network local resource access to a logically remote device. Specifically, the described arrangements and procedures are directed to receiving a message in a local private network. The message having been communicated from a computer that is logically located in a remote private network. The message corresponds, to an operational request that has been directed by the computer to a resource of the local private network. Responsive to receiving the message, the described arrangements and procedures generate and communicate the operational request to the resource for processing.

### TECHNICAL FIELD The described subject matter relates to networked resource access.

### BACKGROUND

Virtual Private Networking (VPN) technology allows a user working at home, a branch office, or on the road to obtain a remote access connection to an organization's networked resources in an intranet using the infrastructure provided by a public network such as the Internet. From the user's perspective, the VPN is a point-to-point connection between the computer, the VPN client, and an organization's server, the VPN server. For the user, the intermediate routing infrastructure of the Internet is not visible, and it appears logically as though the user is connected to the organization's private intranet over a dedicated private link.

Firewalls typically provide intranet security by strictly regulating data that comes into an intranet from a public network such as the Internet. To accomplish this, a firewall filters packets to allow or disallow the flow of very specific types of network traffic. Thus, intranet firewalls define or regulate precisely those devices (i.e., computers, users, etc.) and data that are allowed access to private network resources.

Although this type of intranet architecture secures a private network's resources, the architecture is also problematic for a number of reasons. For instance, if a user decides to utilize the benefits of VPN technology to work within a private intranet from a remote location, certain networked resources that may have otherwise been available to the user at the remote location (i.e., before the VPN connection was established) will typically no longer be accessible by the user.

To illustrate this consider the following example, wherein a hotel's (or some other entity's) LAN is connected to any number of resources or peripheral devices (e.g., a printer, a scanner, public network access, and so on) to allow convenient guest, visitor, customer, employee, and/or so on, access and use of such resources. A user connecting a computing device (e.g., PC, laptop, personal digital assistant (PDA), etc.) into the hotel's LAN at this point is typically able to access these resources over the LAN.

However, once the user tunnels into another private network or intranet (e.g., using the LAN's public network access or another internet service provider (ISP) service to establish a VPN connection), even though that user is still physically connected behind the hotel LAN's firewall, the user typically can not access, or for that matter, even see any of the resources that are provided by the hotel's LAN. This is because the intermediate infrastructures of the hotel's LAN and the routing infrastructure of the public network (used to establish the VPN connection to the private intranet) are no longer visible to the user. Rather, the user appears to be logically connected to the other enterprises' private intranet over a dedicated private link. All of the user's network traffic is now filtered by the other enterprise's firewall.

Moreover, the remote location's firewall (in this example, the hotel LAN's firewall) typically filters or blocks network traffic, including the user's data packets, from entering the remote location's LAN from the user's logically connected location in the other enterprises'intranet. This ensures security for the enterprise.

The following described subject matter addresses these and other problems of accessing resources in a local private network while connected to a logically remote private network.

### SUMMARY

The following described subject matter provides private network local resource access to a logically remote device. Specifically, the described arrangements and procedures are directed to receiving a message in a local private network. The message having been communicated from a computer that is logically located in a remote private network. The message corresponds, to an operational request that has been directed by the computer to a resource of the local private network. Responsive to receiving the message, the described arrangements and procedures generate and communicate the operational request to the resource for processing.

### BRIEF DESCRIPTION OF THE DRAWINGS

The same numbers are used throughout the drawings to reference like features and components.

FIG. 1 shows an exemplary system providing a computer that is logically located in a remote private network, access to a local private network resource, wherein the local and remote private networks are independent of one-another.

FIG. 2 shows aspects of an exemplary server computing device to provide client access to local private networked resources while the client is connected to a remote intranet over a single-tunnel VPN.

FIG. 3 shows aspects of an exemplary client computing device to access locally private network resources while the client is logically located in a remote private network.

FIG. 4 shows aspects of an exemplary local private network peripheral device.

FIG. 5 shows an exemplary procedure providing client access to local private network resources while the client is logically located in a remote private network.

### DETAILED DESCRIPTION

Overview

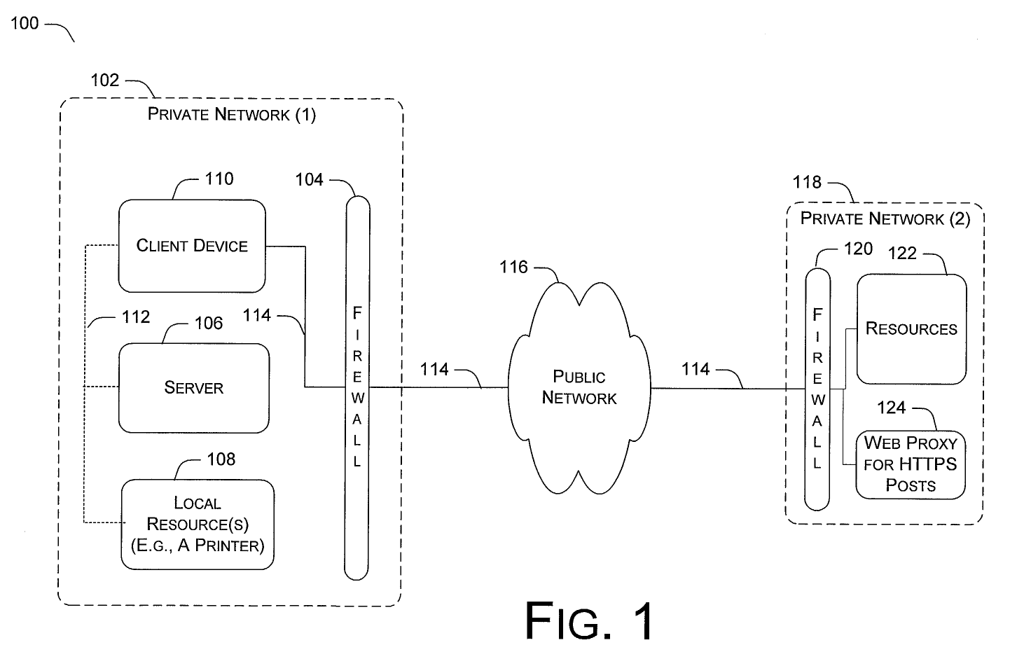

The described arrangements and procedures allow a client device to access local resources (e.g., a printer, scanner, data storage device, digital camera, and so on) while the client is connected to a remote intranet over a single-tunnel VPN connection. To accomplish this, a server inside a local private network includes a web server to facilitate communication between one or more devices on that local private network and the client computer. The Web server can be accessed by the client via a Universal Resource Locator (URL) address. The client computer is configured in advance-i.e., before the user connects to the remote intranet via the VPN connection to access the local resource by sending data and commands to the resource via secure data posts (e.g., HTTPS data posts) that are addressed to the mapped URL. Responsive to receiving these URL address directed data and commands, the server directs them to the local resource in a resource compatible format. In this manner, and as described in greater detail below in reference to FIGS. 1-5, the client is able to access and use local resources even when the client is logically connected to another enterprises' private intranet over a dedicated private link (i.e., a VPN connection).

Secure data posts are used because an enterprise network typically includes one or more web proxies in their firewall that allow HTTP and HTTPS connections outside their enterprise network. This allows individuals within the enterprise browse the web. This same mechanism is used to post a print job to another private network server.

An Exemplary System

FIG. 1 shows an exemplary system 100 to provide client access to local private network resources while the client is logically connected to another enterprises' private intranet over a dedicated private link. The system 100 includes a first intranet 102 belonging to an organization and accessible only by the organization's members, employees, or others with authorization. A firewall 104 surrounding the intranet 102 limits unauthorized access to any of the intranet's local resources. Such resources include, for example, a server 106 and one or more peripheral devices 108 such as printers, scanners, storage devices, and so on.

Communication path 112 represents an operative communication pathway between one or more client devices 110 and the intranet's 102 resources (e.g., the server 106 and the peripheral 108). This communication path 112 is any combination of a parallel connection, a packet switched network (e.g., an organizational intranet network), the Internet, and/or other communication configurations that provide electronic exchange of information between client devices 110 and one or more intranet 102 resources using an appropriate protocol (e.g., TCP/IP, UDP, SOAP, etc.).

The communication path 112 is illustrated as a dotted-line to represent the selective access of the one or more client devices 110 to the intranet's 102 resources across the communication path 112. This means that once a respective client device 110 obtains a remote access connection 114 (e.g., a single-tunnel VPN connection across communication pathway 114) using a public network 116 infrastructure to another intranet 118, the first intranet resource's (e.g., server 106 and peripheral 108) are no longer accessible or even visible to the respective client device 110 across the communication pathway 112 (whereupon, the respective client device 110 would then have access to one or more of the other private network's 118 resources 122).

Although communication path 112 is not available for client 110 access to a resource 108 when the client 110 is tunneled into the other intranet 118, the client 110 is pre-configured (i.e., prior to connecting to the other intranet 118) to access one or more of the resources 108 via a secure data post (e.g., an HTTPS post) to a URL that has been pre-assigned to the server 106. The URL may or may not be “mapped” at the server 106 to a particular resource.

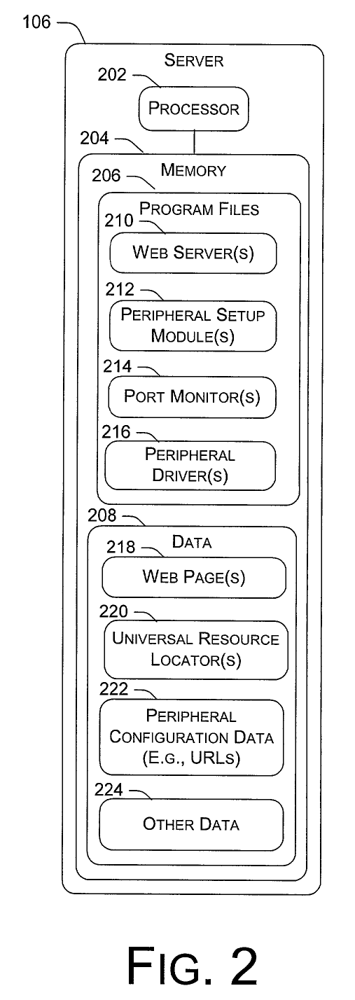

For instance, the secure data post from the client 110 to the server 106 can include a header to specify a particular device, or the URL can be mapped to the particular local resource 108. Either way will work, a separate URL per local device 110 (that may, or may not, all point to different web services 108), or a URL to the server 106 that uses the HTTP(S) headers to determine destination resources 109 for the data and/or commands that are embedded in the secure data post from the client 110. These aspects are described in greater detail below in reference to FIGS. 2 through 5.

An Exemplary Server

FIG. 2 shows aspects of an exemplary server computing device 106 of FIG. 1, for providing client 110 access to local resources 108 of FIG. 1 while the client 110 is connected to a remote intranet 118 over a single-tunnel VPN 114 connection. The server 106 includes a processor 202 that is coupled to a system memory 204. The system memory 204 includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, etc.

The processor 202 is configured to fetch and execute computer program instructions from application programs 206 such as the Web server 210, the peripheral setup module 212, a port monitor 214, a device driver 216, and other program modules 206 such as an operating system (not shown), and so on.

The Web server 210 serves one or more Web pages 218 to a client computer 110 of FIG. 1. The served Web page(s) 218 allow the client computer 110 to download the peripheral setup module 212, or execute the peripheral setup module 212 remotely on the server 106. The peripheral setup module 212 configures the client computer with a port monitor 214, allowing the client computer 110 to access a local resource 108 of FIG. 1 while logically located in another intranet 118 over a VPN connection 114. Specifically, the peripheral setup module 212 either downloads (when executing on the client computer 110) or uploads (when executing on the server 106) the port monitor module 214.

A port monitor module 214 provides an interface between the client computer 110 and a particular peripheral device 108. More particularly, the port monitor 214 is a network port monitor 214 that intercepts commands and/or data from a spooler (e.g., a print command and print data from a print spooler, etc.) between a client application (e.g., a word processing application, a scanning application, a Web browser, etc.) that is executing on the client 110 and the networked LAN resource 108. A spooler is a computer program that controls spooling, or putting jobs on a queue and taking them off. Most operating systems come with one or more spoolers such as a print spooler for spooling documents. In addition, some applications include spoolers. For example, a number of word processors include their own print spooler.

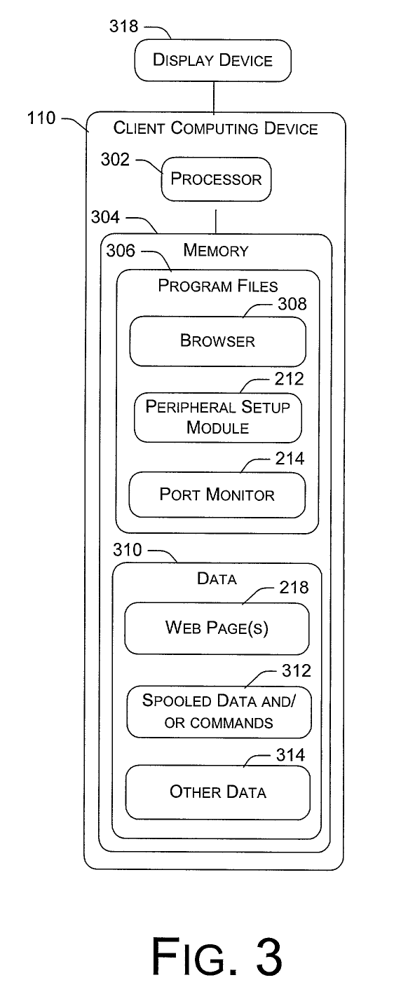

An operational port monitor 214 (a port monitor 214 that has been installed and executed on a client 110) sends information from an application or operating system spooler to the Web server 106. Specifically, the port monitor 214 communicates or routes spooled commands and/or data (i.e., see commands/data 312 of FIG. 3) between the client device 110 and the Web server 210 as secure data posts (e.g., an HTTPS post) over any protocol. This means that once the port monitor 214 has been configured at the client device 110, the client device 110 does not require any device driver(s) to communicate with a particular local device 108.

Data and/or commands 224 that are directed by a port monitor 214 (communicated to the client 110 by the server 106 and installed at the client 110) to the Web server 210 are specifically communicated to the Web servers' 210 URL 220. The URL 220 is optionally a configuration item for a port monitor 214. Server 106 utilized URL 220 to peripheral device 108 mappings can be stored in a peripheral configuration data file 222.

An Exemplary Client Computing Device

FIG. 3 shows aspects of an exemplary client computing device 110 to access local resources 108 of FIG. 1 while logically located in a remote private network 118. The client 110 includes a processor 302 that is coupled to a system memory 304. The system memory 304 includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, etc.

The processor 302 is configured to fetch and execute computer program instructions from application programs 306 such as the browser module 308, the downloaded peripheral setup module 212 of FIG. 2, the downloaded port monitor 214, and other applications such as an operating system (not shown), etc. The browser module 308 is used to access the server 106 of FIG. 2 to download the peripheral device setup module 212 and the port monitor module 214 from the server 106. More particularly, the browser 308 accesses the Web server 210 of FIG. 2 while logically located in the private network 102 to download the peripheral device setup module 212 and the port monitor module 214 from the server 106.

As discussed above with respect to FIG. 2, the peripheral setup module 212 is downloaded from the server 106 of FIGS. 1 and 2 or is accessed remotely. The setup module 212 configures the client computer to access the operations of a local resource 108 of FIG. 1, even when the client is physically located in a LAN 102 and logically located in another intranet 118 using a VPN connection 114. The setup module installs the port monitor module 214 onto the client device 110, each of which have functionality as described above in reference to FIG. 2. If the local peripheral 106 of FIG. 1 is a printer, the setup module 212 optionally sets the printer to be the default printer.

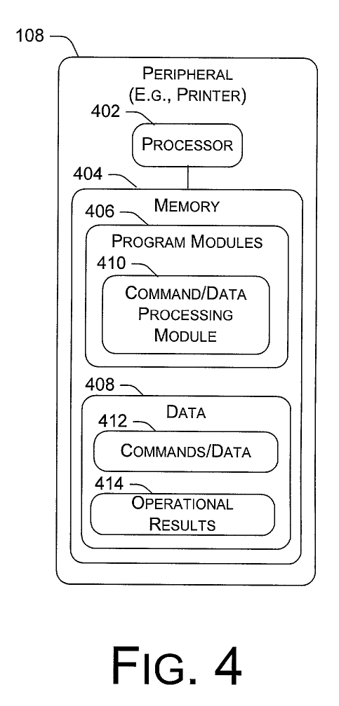

The browser 308 or port monitor 214 optionally receives information 314 (e.g., Web pages, commands, data, and so on) that are communicated from the private network server 106 to the client computer 110. These received other data 314 can be displayed on optional display device 318, which is operatively coupled to the client computer 110. The received information 314 may include peripheral configuration information, an operational status, operational result data (e.g., the operational results 414 of FIG. 4), and so on.

An Exemplary Peripheral (Local Intranet Resource)

FIG. 4 shows aspects of an exemplary local peripheral computing device 108 of FIG. 1. The peripheral 108 can be any type of device such as a general purpose computing device, a printer, a scanner, a digital camera, and so on. The peripheral 108 includes a processor 402 that is coupled to a system memory 404. The system memory includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, etc.

The processor 402 is configured to fetch and execute computer program instructions from application programs 406 such as the command/data processing module 410, an operating system (not shown), and so on. The processor is also configured to fetch and/or store data 408 while executing one or more application programs 406.

The command/data processing module controls the device 108 and processes the data and/or commands 412 that have been communicated to the device 108 from the peripheral driver(s) 216 of FIG. 2 (i.e., communicated by the server 106 of FIGS. 1 and 2). The commands/data 412 include any combination of commands pertaining to the operations of the peripheral 108 and/or data. For instance, if the peripheral is a printer, commands/data 412 includes commands to operate one or more functions of the printer (e.g., print, receive status, etc.), and/or data (e.g., commands/data 412) to print onto print media (e.g., paper, transparencies, etc.).

Responsive to receiving commands/data 412 from the server 106 (e.g., commands extracted from a Web page), the command data processing module 410 communicates the commands/data 412 to the peripheral's operating system for processing (e.g., performing printing, scanning, status requests, data compression, and/or other operations). If a client 110 requested operation (e.g., an operation (e.g., a print request) identified in the received commands 412 has an operational result 414 (e.g., a printing status message, scanned-in image data, and/or the like) the result is optionally communicated by the command/data processing module 410 back to the client 110.

An Exemplary Procedure

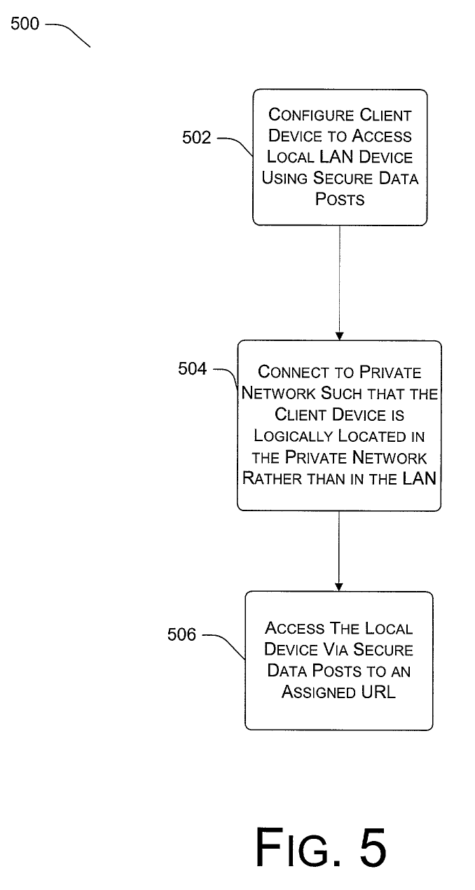

FIG. 5 shows an exemplary procedure providing client 110 access to a local resource 108 in a private network 102 while the client is physically located in the LAN 102 and logically located in a different private network 104. At block 502, the client device 110 is configured to access a local LAN device 108 using secure data posts to a pre-assigned URL.

For example, consider that the LAN 102 is in a hotel and a LAN resource 108 is a printer. Once connected to the hotel's LAN 102, a user uses a Web browser application 308 on the client device 110 to browse to a Web page 218 served by a Web server 210 a hotel server 106. In this example, the served Web page 218 may read as follows: “Welcome Mr. Smith, if you want to use the printer in your room, select this link and your computer will automatically be configured to print to the provided printer” (e.g., the peripheral 108). Responsive to selection of the link, the client device 110 browser downloads configuration software 212, which is then executed to set up access to the new printer 108 through a pre-assigned URL. In this example, the setup software 212 may set the new printer 108 to be the default printer.

At block 504, the client device 110 is connected to the other intranet 118 such that the client device 110, even though physically connected within the LAN 102, is logically located behind a firewall 120 of the other intranet 118. At block 506, the client device uses secure data posts to communicate spooled data and or commands 312 to the server 106; the operational requests 312 corresponding to operations of the local peripheral device 108. For instance, if the peripheral 108 is a printer, the user may need only print to a default printer (e.g., via a word processing application-the user may never see or have to even know that the port monitor 214 and the peripheral driver 216 are configured to access the peripheral 108 through the server 106 and the URL 220). In this manner, even when the user has tunneled or logically situated a computing device 110 behind a firewall 120 in another network 118, the client 110 can access local LAN 102 resources.

Computer-Readable Media

The subject matter of FIGS. 1 through 5 is illustrated as being implemented in a suitable computing environment. Although not required, the subject matter is described in the general context of computer-executable instructions, such as the program modules 206, 306, and 406 of FIGS. 2-4, that are respectively executed by either the server 106, the client device 110, or the peripheral device 108. Program modules typically include routines, programs, objects, components, data structures, etc., that perform particular tasks or implement particular abstract data types. Additionally, those skilled in the art will appreciate that the described arrangements and procedures may be practiced with other computer system configurations, including multi-processor systems, microprocessor-based or programmable consumer electronics, network PCs, minicomputers, mainframe computers, and so on. In a distributed computing environment, program modules may be located in both local and remote memory storage devices (computer-readable media).

Conclusion

Although the subject matter has been described in language specific to structural features and/or methodological operations, it is understood that the arrangements and procedures defined in the appended claims is not necessarily limited to the specific features or operations described. Rather, the specific features and operations are disclosed as preferred forms of implementing the claimed subject matter.

1. A method providing private network local resource access to a logically remote device, the method comprising:
receiving a message in a local private network, the message being communicated from a computer that is logically located in a remote private network, the message corresponding to an operational request directed by the computer to a resource of the local private network;
responsive to receiving the message:
generating the operational request; and
communicating the operational request to the resource for processing.

2. A method as recited in claim 1, wherein the message is communicated over a single-tunnel VPN connection from the local private network, the local private network being independent of the remote private network.

3. A method as recited in claim 1, wherein the message is a secure data post directed to the resource.

4. A method as recited in claim 1, wherein the message is a secure data post based on the HTTPS protocol.

5. A method as recited in claim 1, wherein the resource is a printing device.

6. A method as recited in claim 1, wherein the resource is a scanning device.

7. A method as recited in claim 1, wherein the computer is configured to communicate commands and/or data to a URL identifying a server in the local private network, the server controlling access to the resource from the remote private network.

8. A method as recited in claim 1, wherein the computer is not configured to communicate the operational request to a device driver specifically designed to control input and/or output respectively to/from the resource.

9. A method as recited in claim 1, wherein the message comprises a command and/or a datum corresponding to the operational request, and wherein the method further comprises communicating, by the resource, information to the computer, the information corresponding to the operational request.

10. A method as recited in claim 1, wherein the message was directed to a URL address corresponding to a server located in the local private network, and wherein the message further comprises information to identify the resource.

11. A method as recited in claim 1, wherein the message was directed to a URL corresponding to a server located in the local private network, and wherein the method further comprises:
mapping, by the server, the URL to the resource.

12. A method as recited in claim 1, further comprising configuring the computer to generate the message in a particular manner to indicate a desired operation of the resource, the particular manner being a function of whether the computer is logically located in the remote private network; or whether the computer is logically located in the local private network, such that the configuring is perform prior to the computer being connected to the remote private network.

13. A method as recited in claim 1, wherein the message is received by a server in the local private network, and wherein the method further comprises before the act of receiving, an act of communicating, by the computer, a secure data post comprising the message.

14. A computer-readable medium comprising computer executable instructions providing private network local resource access to a logically remote device, the computer-executable instructions comprising instructions for:
receiving a message in a local private network, the message being communicated from a computer that is logically located in a remote private network, the message corresponding to an operational request directed by the computer to a resource of the local private network;
responsive to receiving the message:
generating the operational request; and
communicating the operational request to the resource for processing.

15. A computer-readable medium as recited in claim 14, wherein the message is communicated over a single-tunnel VPN connection from the local private network, the local private network being independent of the remote private network.

16. A computer-readable medium as recited in claim 14, wherein the message is a secure data post directed to the resource.

17. A computer-readable medium as recited in claim 14, wherein the message is a secure data post based on the HTTPS protocol.

18. A computer-readable medium as recited in claim 14, wherein the resource is a printing device.

19. A computer-readable medium as recited in claim 14, wherein the resource is a scanning device.

20. A computer-readable medium as recited in claim 14, wherein the computer is configured to communicate commands and/or data to a URL identifying a server in the local private network, the server controlling access to the resource from the remote private network.

21. A computer-readable medium as recited in claim 14, wherein the computer is not configured to communicate the operational request to a device driver specifically designed to control input and/or output respectively to/from the resource.

22. A computer-readable medium as recited in claim 14, wherein the message was directed to a URL address corresponding to a server located in the local private network, and wherein the message further comprises information to identify the resource.

23. A computer-readable medium as recited in claim 14, wherein the message comprises a command and/or a datum corresponding to the operational request and wherein the instructions further comprises communicating, by the resource, information to the computer, the information corresponding to the operational request.

24. A computer-readable medium as recited in claim 14, wherein the message was directed to a URL corresponding to a server located in the local private network, and wherein the instructions further comprise mapping, by the server, the URL to the resource.

25. A computer-readable medium as recited in claim 14, further comprising instructions for configuring the computer to generate the message in a particular manner to indicate a desired operation of the resource, the particular manner being a function of whether the computer is logically located in the remote private network; or whether the computer is logically located in the local private network, such that the configuring is perform prior to the computer being connected to the remote private network.

26. A computer-readable medium as recited in claim 14, wherein the message is received by a server in the local private network, and wherein the computer-executable instructions further comprise, before the instructions for receiving, instructions for communicating, by the computer, a secure data post comprising the message.

27. A system providing private network local resource access to a logically remote device, the system comprising:
processing means for:
receiving a message in a local private network, the message being communicated from a computer that is logically located in a remote private network, the message corresponding to an operational request directed by the computer to a resource of the local private network;
responsive to receiving the message:
generating the operational request; and
communicating the operational request to the resource for processing.

28. A system as recited in claim 27, wherein the message is communicated over a single-tunnel VPN connection from the local private network, the local private network being independent of the remote private network.

29. A system as recited in claim 27, wherein the resource is a printing or scanning device.

30. A system as recited in claim 27, wherein the message was directed to a URL corresponding to a server located in the local private network, and wherein the processing means further comprise means for mapping, by the server, the URL to the resource.

31. A system as recited in claim 27, further comprising means for configuring the computer to generate the message in a particular manner to indicate a desired operation of the resource, the particular manner being a function of whether the computer is logically located in the remote private network; or whether the computer is logically located in the local private network, such that the configuring is perform prior to the computer being connected to the remote private network.
